(19) United States
(12) Patent Application Publication
(10) Pub. No.: US 2009/0014466 A1
(43) Pub. Date: Jan. 15, 2009

(54) Method and apparatus for advertising adjacent to a beverage dispenser to facilitate advertising income device placement in high traffic venues

(75) Inventors: Michael Saveliev, Huntington Beach, CA (US); James R. Schuster, Las Flores, CA (US)

Correspondence Address: GREENBERG TRAURIG (PHX), INTELLECTUAL PROPERTY DEPARTMENT, 2450 COLORADO AVENUE , SUITE 400E, SANTA MONICA, CA, 90404, US

(73) Assignee: SHURflo, LLC, Cypress, CA (US)

(21) Appl. No.: 12/217,684

(22) Filed: Jul. 8, 2008

Related U.S. Application Data
(63) Continuation of application No. 09/976,677, filed on Oct. 12, 2001, now abandoned.

(51) Int. Cl. B67D 5/06; G06Q 30/00

(52) U.S. Cl. 222/1; 222/23; 705/34

(57) ABSTRACT

An apparatus and method for advertising adjacent to a beverage dispenser to reduce the cost of placing and maintaining a beverage dispenser in a retail outlet. A beverage dispenser, and most preferably a beverage dispenser that is specially equipped to display advertisements for at least one of the beverages being dispensed, is placed in a retail outlet. The advertisements are displayed over a period of time and preferably the amount of beverage dispensed during that time period is tracked and recorded. The amount of beverage dispensed can then be used to calculate an advertising fee to be paid by the beverage producer. The advertising fee is used to offset the purchase or lease price of the beverage dispenser, and is most preferably paid directly to the preferred provider of the beverage dispenser.

### FIELD OF THE INVENTION

The present invention relates to beverage dispensers, and more particularly to methods and apparatuses for advertising adjacent to the beverage dispenser to facilitate advertising revenue from placement of the devices at high visibility, high traffic venues or retail establishments.

### BACKGROUND OF THE INVENTION

The beverage industry spends billions of dollars each year marketing a large assortment of products, including beer, wine, liquor, soft-drinks, water, sports drinks, juices, etc. For beer and soft-drink producers, television advertisements are the cornerstone of the advertising campaigns. Large amounts of time and money are spent creating advertisements that appeal to consumers. These advertisements are often humorous, glamorous, or otherwise appealing and are enjoyed and talked about by viewers worldwide. Producers of such advertisements also spend enormous amounts of money to purchase television air time needed to show the advertisements during key time slots. Beer and soft-drink advertisements are prevalent during televised sporting events and concerts, and target viewers who are likely to attend such events. Beer and soft-drink advertisers also often advertise products in other public venues such as restaurants, bars, festivals, parties, and the like.

Competition for these public venues is fierce among beverage producers, each wanting their product to be the only product available to the public in a given venue. In addition to simply selling their beverage product to the consumers at these venues, producers also recognize that the venues provide a good atmosphere for marketing their product. Based on the type of event being held at the venue, the producers know which demographic groups of consumers will be in attendance. These groups can then be targeted with appropriately tailored marketing campaigns.

As a condition of selling their products, producers often require or strongly recommend that venues use specific dispensing equipment. The equipment is often specially designed to dispense the beverage in the manner preferred by the producer to ensure that a quality beverage is served to the customer every time. In addition, the equipment is usually outfitted with signs, decals, and logos that advertise the producer's product and build name and brand recognition.

Venues usually buy or lease beverage dispensing equipment from a preferred provider. The cost of the equipment is often a major issue when retailers consider the lease or purchase of such dispensing equipment. Commonly, the high quality dispensing equipment recommended by the beverage producer is foregone due to the relatively high cost of the equipment. To the detriment of the producers, the retailers will often purchase less expensive equipment that may not dispense the beverage in the manner preferred by the producer to produce the highest quality serving.

In light of the problems and limitations of the prior art described above, a need exists for a new beverage dispenser and a method of supplying this new beverage dispenser to retailers that lowers the cost of the dispenser to the retailer; makes the producer's brand of beverage more attractive to the retailer; makes the producer's brand of beverage more attractive to the consumer; and offers additional advertising opportunities that will ultimately benefit producers, retailers and consumers. Each preferred embodiment of the present invention achieves one or more of these results.

### SUMMARY OF THE INVENTION

The present invention is a method and apparatus for showing an advertiser's video advertisement and/or for playing an advertiser's audio advertisement adjacent to a beverage dispenser used in a public venue. In exchange for the right to advertise in the retailer's venue using the retailer's equipment, the producer pays a fee which helps offset the retailer's cost of buying or leasing the beverage dispenser. The fee is paid directly to the preferred provider of the beverage dispenser, or alternatively, can be paid directly to the retailer if the applicable local laws, rules, and regulations permit such payment. When negotiating with a retailer for obtaining an account therewith, the producer can describe the dispenser recommended for use with the product and can discuss the options the retailer has for obtaining the dispenser. One of the options is the prior art method of having the retailer buy or lease a standard dispenser directly from a preferred provider at the normal price. The option of one preferred embodiment of the present invention is to have the retailer buy or lease a dispenser that is specially equipped to play television-type and/or radio-type advertisements and preferably record data relating to the amount of beverage dispensed while the advertisements are playing, and optionally to record data relating to the number of times and time of day the advertisements are played. This specially equipped dispenser is also preferably purchased directly from the preferred provider. While this specially equipped dispenser can be more expensive than some dispensers due to the added advertising equipment, the cost to the retailer will be offset by the advertising fees paid by the producer. Producers can buy advertising time from retailers for a negotiated fee.

In addition to offsetting the cost of the dispenser, the advertisements are also popular with consumers, which ultimately benefits the retailer. Most preferably, consumers are able to select their favorite television or radio advertisements and see or hear them on demand while waiting to purchase a beverage. The present invention can also be used to broadcast live events, television, sporting events, concerts, scores, news, contests, or other forms of information or entertainment. Advertisements, prices, drink specials, and the like can be incorporated into these displays in the form of subtitles, commercial interruptions, scrolling text or the like, thereby enticing consumers to view the advertisements and to approach the retailers. In public venues where long lines are prevalent, this entertainment will provide customers an enjoyable distraction while waiting in line.

Producers are also benefited by the apparatus and method of the present invention. Public venues provide a target-rich environment for playing new or preexisting television or radio advertisements that are otherwise seen or heard only during network broadcasting. Ideally, the advertisements will influence consumers who are waiting in line to purchase the producer's product over competing products that are also available. If different stands are set up to sell different products, the advertisements may influence the consumer to choose the producer's product simply because the wait in line for the producer's product will be more enjoyable than the wait in line for a competing product.

The present invention can also be used to distribute prizes or other incentives such as free drinks, brewery branded clothing, discounts, or public recognition. Because the present invention can track the number of beverages dispensed, the present invention can, for example, be used to award prizes to whoever purchases the 50^{th} beer or the 100^{th} root beer. Most preferably, the present invention broadcasts a particular slogan, sales pitch, or sound bite when a winner is selected, thereby drawing more attention to the vendor and the product.

Finally, the preferred providers of the specially equipped dispensers will be benefited by the apparatus and method of the present invention. Retailers will be driven to purchase or lease the specially equipped dispensers from the preferred providers by the desire for advertising revenues that will ultimately lower the cost of the dispenser. Consumer demand for the popular dispensers will also drive retailers to purchase or lease the specially equipped dispensers. In return, the preferred providers will sell more specially equipped dispensers.

The apparatus of the present invention can take a number of different forms. For example, the dispenser can incorporate one or more viewing or auditory devices connected to one or more output devices that supply the selected advertisements. The dispenser can trigger visual or audio messages to begin after or while a beverage is dispensed. A metering device is preferably coupled to the dispenser and preferably keeps track of how many beverages are sold while the advertisements are displayed. An optional counter can also or instead be used to track the time of day and the number of times each advertisement is displayed. The metering device can optionally track total beverage volume dispensed for desired time periods. Also, the metering device can be used to rotate the particular advertisements or messages. For example, after every twentieth beverage is dispensed the present invention can display a new advertisement.

The size and number of viewing and auditory devices can be selected to suit the venue in which the dispenser will be used. For example, in smaller bar or tavern applications, the dispenser can incorporate as few as one small viewing device built into or otherwise located near the dispenser. For larger applications, such as sporting events where the lines are often very long, the dispenser can incorporate multiple large-screen viewing devices that can be built into the dispenser, placed in selected locations along the line, and/or elevated above the line and the dispenser. These larger applications can also employ additional sound systems which can be connected to the output device to transmit an optional audio component of the advertisements. Hereinafter and in the appended claims, the term “display” means that the advertisement is presented (i.e., shown, exhibited, demonstrated, transmitted, or otherwise broadcast) visually, audibly, or both visually and audibly in whole or in part. Accordingly, the term “display” as used herein and in the appended claims does not necessarily refer to visual media.

The present invention addresses the problem of producers losing potential accounts due to the costs associated with buying or leasing recommended dispensing equipment. By providing the option of using a dispenser that is equipped to display advertisements, and thereby generate revenues, the producers can greatly offset or even eliminate the cost of the specialized dispensing equipment. Producers have an incentive to recommend these specially equipped dispensers to the retailers in order to take advantage of the excellent marketing opportunity of the public venue. Retailers have the incentive to purchase the specially equipped dispensers since the ultimate price can still be lower than less expensive standard dispensers and the consumer demand for these entertaining dispensers will be high.

Further objects and advantages of the present invention, together with the organization and manner of operation thereof, will become apparent from the following detailed description of the invention when taken in conjunction with the accompanying drawings, wherein like elements have like numerals throughout the drawings.

### BRIEF DESCRIPTION OF THE DRAWINGS

The present invention is further described with reference to the accompanying drawings, which show preferred embodiments of the present invention. However, it should be noted that the invention as disclosed in the accompanying drawings is illustrated by way of example only. The various elements and combinations of elements described below and illustrated in the drawings can be arranged and organized differently to result in embodiments that are still within the spirit and scope of the present invention.

In the drawings, wherein like reference numerals indicate like parts:

FIG. 1 is a schematic representation of an apparatus according to a preferred embodiment of the present invention;

FIG. 2 is a schematic representation of an apparatus according to another preferred embodiment of the present invention; and

FIG. 3 is a flow-chart illustrating a method according to a preferred embodiment of the present invention.

### DETAILED DESCRIPTION OF THE PREFERRED EMBODIMENTS

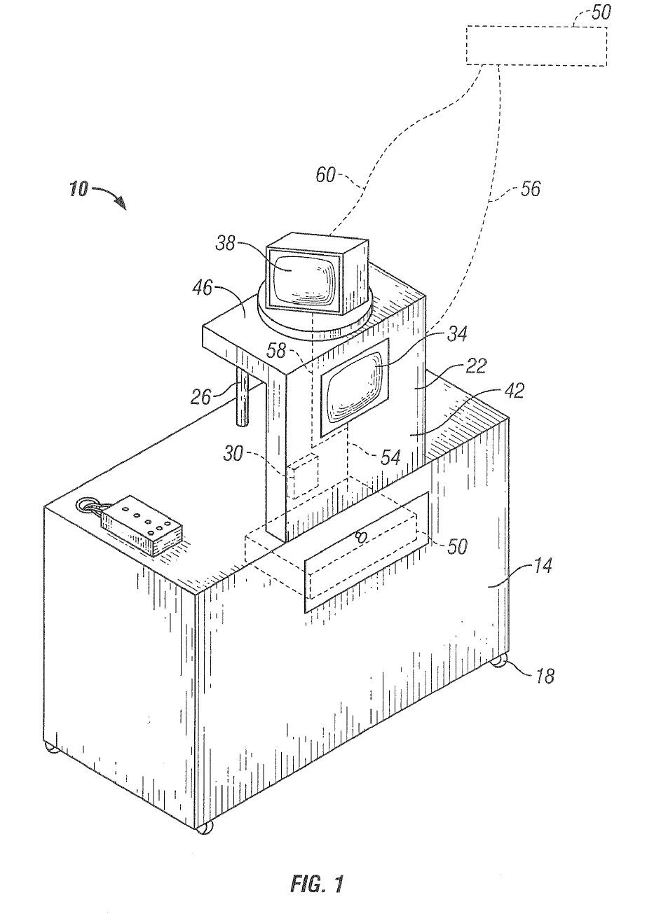

A preferred application in which the present invention can be used is shown in FIG. 1. In the illustrated embodiment, the beverage dispenser 10 is located in a public venue or retail outlet. As used herein and in the appended claims, the terms “public venue” and “retail outlet” mean any location where members of the public at large or select groups of the public at large would gather and have the opportunity to drink beverages dispensed from the beverage dispenser 10, including, but not limited to, restaurants, convenience stores, bars, taverns, arenas, stadiums, theaters, cafeterias, festivals, concert halls, public sporting or dining clubs, private sporting or dining clubs, casinos, parks, and various tourist attractions. The beverage dispenser 10 can be used to display advertisements to be viewed and/or heard by customers in or near the retail outlet. The beverage dispenser can also display live events, television programs, sporting events, concerts, scores, news, contests, or other forms of information or entertainment. Preferably, advertisements can be interspersed or incorporated into these other forms of entertainment. Most preferably, advertisements, prices, drink specials, and the like can be incorporated into and with these forms of entertainment in the form of subtitles, commercial interruptions, scrolling text, or the like. Therefore, as used herein and in the appended claims, the term “advertisement” is intended to include any form of audio or visual display which can be used to inform, entice, pursued, or entertain customers in public venues and retail outlets. The beverage dispenser 10 depicted in the figures is one representative of several sizes and styles of dispensers available from SHURflo Pump Manufacturing Company of Orange, Calif. The present invention is not intended to be limited to the dispenser configuration shown in the figures, but rather could be practiced with any size or style beverage dispenser known or yet unknown.

The beverage dispenser 10 preferably includes a cabinet portion 14 supported by support members 18, which can take the form of wheels (as shown) or can alternatively take the form of any suitable supporting elements such as legs, sliding casters, etc. A tower 22 extends from the cabinet portion 14 and preferably includes a plurality of beverage supply nozzles 26 that dispense beverage to the containers (not shown) held below. The tower 22 can take any shape desired, such as the L shape shown in the figures. The dispenser 10 preferably also includes a beverage metering device 30 (represented schematically in FIG. 1) that tracks and records the amount of beverage dispensed through the nozzles 26. The beverage metering device 30 is conventional in nature and operation and can be of any suitable construction. For example, the beverage metering device 30 can track and record the number of individual sales and the corresponding serving sizes dispensed at each sale, and/or can track and record the total quantity of beverage dispensed. The beverage metering device 30 can also include a timing device 32 which, acting in conjunction with the metering device 30, can record the rate at which a beverage is dispensed and/or coordinate these rates with time of day, day of week, or the like. In addition, the timing device 32 can record the rate at which a beverage is dispensed while or after particular advertisements are displayed. The beverage metering device 30 can include a readout display that is located on the beverage dispenser 10, or alternatively can be linked to a readout display remote from the beverage dispenser 10. Technology capable of such tracking and recording operations is known in the beverage dispensing industry and is not therefore described in greater detail herein.

The beverage dispenser 10 also preferably includes at least one viewing device 34 adjacent thereto or mounted therein or thereon. In the illustrated preferred embodiment, two viewing devices 34 and 38 are associated with the dispenser 10. The viewing device 34 is shown coupled to an outwardly facing planar surface 42 of the tower 22 and takes the form of a flat-screen monitor or flat-screen television that can be built into the outwardly facing planar surface 42 or can be attached to the outwardly facing planar surface 42 by any suitable fastening method. The viewing device 38 is shown coupled to an upper surface 46 of the tower 22 and takes the form of a typical monitor or television set. The viewing device 38 can be rotatably coupled to the upper surface 46 to allow the viewing device 38 to be rotated for viewing from different locations with respect to the dispenser 10.

The locations of the viewing devices 34 and 38 on the dispenser 10 as shown in FIG. 1 are only two examples of the various locations and mounting orientations possible for viewing devices of the present invention. Other mounting locations and orientations are possible and fall within the spirit and scope of the present invention. For example, one or more viewing devices could be mounted at various locations on or in the cabinet portion 14. Additionally, according to the invention it is not necessary for any viewing devices to be mounted to the beverage dispenser 10 as shown in FIG. 1. Instead, the viewing devices can be located adjacent to the dispenser 10 in the retail outlet.

The viewing devices 34 and 38 can be of any construction capable of displaying a video signal, including but not limited to standard picture tube-type televisions or monitors, rear projection-type televisions or monitors, and flat-screen televisions or monitors having liquid crystal or other types of displays. Front projection-type display systems can also be used in conjunction with a screen mounted adjacent to the beverage dispenser 10. In some preferred embodiments, at least one of the viewing devices 34 and 38 includes a touch-screen feature wherein commands can be given by simply touching the appropriate area of the viewing screen. Additionally, the viewing devices 34 and 38 can be any size or shape desired to suit the needs of the retail outlet in which the beverage dispenser 10 is placed. For example, the beverage dispenser 10 illustrated in FIG. 1 is suitable for any retail outlet application, but is well-suited for smaller retail outlets wherein long lines are not prevalent (such as in a restaurant, bar, or tavern). The viewing devices 34 and 38 can include built-in speakers that transmit an audio signal accompanying the video signal displayed by the viewing devices 34 and 38. Alternatively or in addition, separate speakers (not shown) can be positioned adjacent to the dispenser 10 to transmit the audio signal. The dispenser 10 can employ any number of viewing devices and/or audio devices for displaying advertisements to a consumer in or near the retail outlet.

At least one output device 50 is coupled to the viewing devices 34 and 38 and can be located adjacent to or remote from the beverage dispenser 10. The output device 50 is capable of providing a signal to the viewing devices 34 and 38 and/or to the audio devices (not shown in FIG. 1) to display advertisements having at least one of a video component and an audio component, and preferably both. Preferably, the advertisements displayed are for at least one of the beverages being dispensed by the dispenser 10. In FIG. 1, the output device 50 is shown schematically located inside the cabinet portion 14 and is coupled to the viewing devices 34 and 38 via any suitable connection capable of transmitting the video and audio signals to the viewing devices 34 and 38 and audio devices. For example, cables 54 and 58 are shown schematically connecting the output device 50 to the viewing devices 34 and 38, respectively. In this embodiment, the cables 54 and 58 can preferably be routed inside the cabinet portion 14 and tower 22, and thereby kept hidden from view and substantially out of the way of customers and operators. Alternatively, the output device 50 can be located remote from the viewing devices 34 and 38 (as shown in phantom in FIG. 1) and can be coupled to the viewing devices 34 and 38 with cables 56 and 60 that run outside of the beverage dispenser 10.

The output device 50 can be any device capable of providing at least one of a video and audio signal to the viewing devices 34 and 38 and/or audio transmitting devices (i.e., speakers, headphones, etc.—not shown). For example, the output device 50 can include a VCR, a DVD player, a cable television controller, a satellite television controller, a laser-disc player, a computer processor, or any other suitable device. If only an audio component is desired, the output device 50 can include a cassette tape player, a DAT player, a CD player, or any other suitable device. In a preferred embodiment, the output device 50 takes the form of a DVD player or computer processor capable of quickly switching between a selection of available advertisement options such that the customer can select his or her favorite advertisements for display. As described above, one preferred embodiment of the invention provides for such a selection through touch-screen capability of at least one of the viewing devices 34 and 38. A menu of available advertisements can be displayed on the viewing devices 34 and 38 with instructions for the customer to touch the portion of the screen corresponding to the desired advertisement. Upon touching the screen, a signal is sent to the output device 50 to play the desired advertisement. Of course, alternative methods of selecting a desired advertisement are contemplated by the invention. For example, a keypad or keyboard could be used to select the desired advertisement. In some preferred embodiments, the output device 50 also has capabilities to randomly select advertisements to be displayed without any input from the customers or to continuously display one or more advertisements in any order desired. In the event that a VCR is used as the output device 50, the tapes containing the advertisements could be looped for continuous running. Multiple VCRs or other output device types could be used to offer and selectively display a number of advertisements from which the customer could choose.

The beverage dispenser 10 is operated such that advertisements are displayed continuously or intermittently and are shown in either a predetermined order, randomly, upon selection by a customer, or any combination of these, preferably during periods when the retail outlet is open for service. In one highly preferred embodiment of the present invention, particular advertisements are displayed after the beverage dispenser 10 dispenses a predetermined quantity of beverage. For example, after one beer is dispensed output device 50 and/or viewing devices 34, 38 are activated and an advertisement is displayed. Then, after every fiftieth beer is dispensed, a new advertisement is displayed. Alternatively, a different video or audio clip can be played each time a beer is dispensed. Special promotions can also be integrated into the present invention. For example, when a consumer purchases the winning one-hundredth beer, a message or announcement can be made that he or she has just won a prize for purchasing the one-hundredth beer. Preferably, such special promotions will involve the customers and add additional emphasis to a particular product. The prizes themselves, such as clothing emblazoned with brewery logos, drink discounts, and the like, can advertise or promote particular products or specials.

Preferably, the beverage metering device 30 keeps track of the amount of beverage dispensed while the retail outlet is open for service. An advertising fee can then be determined based on the number of beverage servings dispensed and/or the volume of beverage dispensed while the advertisements were being displayed. The correlation between the number of servings or total volume of beverage dispensed and the time period over which the advertisements were displayed provides a good indication of the number of customers who viewed the advertisements and thus provides a reasonable basis for calculating the advertising fee. Of course, the present invention can include other methods of determining the advertising fee. For example, a counter (not shown) that is built into or coupled to the output device 50 in any conventional manner can track the total number of times an advertisement is displayed over a period of time, from which the advertising fee can be determined. Such a counter could optionally include a feature that determines and records the time of day the advertisements were run. More sophisticated systems that can track and use any combination of the above-described data can also be used. Regardless of the manner of determining the advertising fee due, the revenue generated by the advertising can be used to offset the cost of the beverage dispenser 10 as will be described in further detail below.

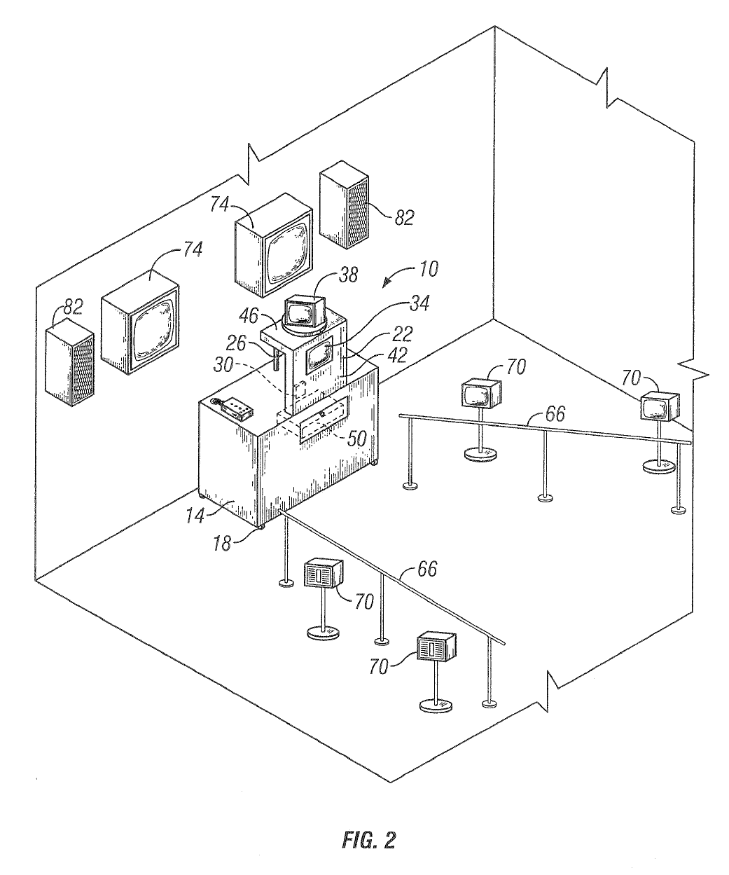

FIG. 2 illustrates another preferred embodiment of the invention, wherein the beverage dispenser 10 is located in a retail outlet where large lines are prevalent. For example, the embodiment illustrated in FIG. 2 would be well-suited for use at concession stands in arenas, stadiums, festivals, parks, theaters, tourist attractions, etc. Rope lines 66 delineate customer line boundaries, but are not a necessary feature of the invention. Because the viewing devices 34 and 38 may be difficult to see by customers at the rear of the line, additional viewing devices 70 and 74 can be positioned adjacent to the beverage dispenser 10. For example, viewing devices 70 can be positioned outside the rope lines 66 alongside the line. The viewing devices 70 could also be positioned inside the rope lines 66 and within the line (not shown). Additionally, one or more viewing devices 74 can be elevated above the dispenser 10 and/or the line itself to facilitate viewing by most or all customers waiting in line. The viewing devices 70 and 74 can be of any suitable construction as described above with respect to viewing devices 34 and 38, and are preferably large enough to facilitate viewing by most or all customers waiting in line.

In the embodiment of FIG. 2, the output device 50 is coupled to the additional viewing devices 70 and 74 with connector cables or other conventional wiring (not shown) to display the advertisements being shown on the viewing devices 34 and 38. Alternatively, one or more additional output devices (not shown) could be used to display different advertisements on the various viewing devices 70 and 74. Additional speakers 82 are also shown in FIG. 2 and are connected to the output device 50 via connector cables or other conventional wiring (not shown). Yet another alternative arrangement employs one or more of the viewing devices 70, 74 and/or the speakers 82 without the viewing devices 24, 28 and/or speakers described above with reference to the first preferred embodiment of the present invention.

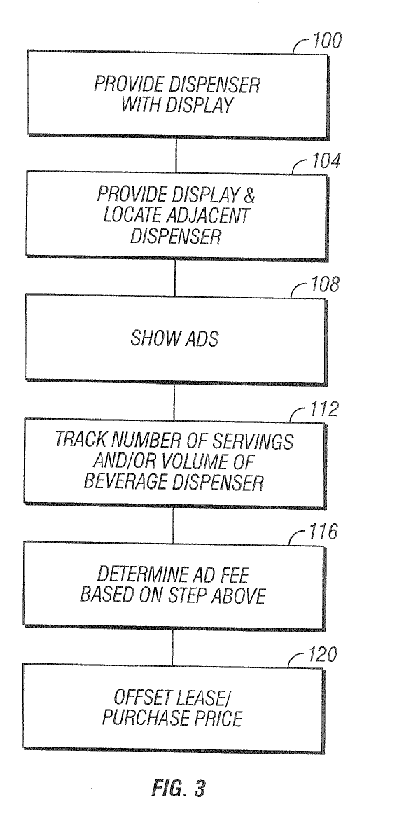

A flowchart illustrating the operation of a preferred embodiment of the present invention is illustrated in FIG. 3. Once the retailer decides which beverage producer to use, the beverage producer recommends a preferred dispenser provider. The preferred provider can give the retailer the option to purchase or lease either a standard beverage dispenser or the specially equipped beverage dispenser 10 described above. Preferably, the prices of the standard dispenser and the specially equipped dispenser 10 are disclosed to the retailer. Then, the preferred provider preferably explains that if the retailer uses the dispenser 10 to display advertisements in the retail outlet, the base price of the dispenser 10 will be offset, and therefore reduced, by the revenues generated by the advertising fees paid by the beverage producer.

The flowchart shown in FIG. 3 begins with the dispenser 10 being purchased or leased by the retailer (block 100). The lease or purchase will typically involve payments or installments at some regular interval (e.g., monthly, quarterly, annually, etc.). Next, the dispenser 10 is placed in the retail outlet, and the desired output devices 50 are connected to the desired viewing devices 34, 38, 70, 74 and/or audio transmitting devices 82 (positioned adjacent to the dispenser 10) and are made operational to display the advertisements (block 104). As stated above, the size and number of viewing devices and audio transmitting devices can vary for different retail outlets. When the retail outlet opens for service, the advertisements are preferably displayed continuously or intermittently at approved intervals, and either in a set pattern, randomly, or as selected by customers (block 108). Again, the advertisements are preferably prepared by the beverage producer and preferably advertise at least one of the beverages being dispensed by the dispenser 10. In a preferred embodiment, the advertisements include preexisting radio or television advertisements known to the customers.

Preferably, the metering device 30 tracks the number of servings dispensed, the total volume of beverage dispensed or any other data that can be used to estimate the number of customers who purchased beverage and therefore likely observed the advertisements (block 112). This data can be used to determine the effectiveness of particular advertisements or promotions. For example, the effectiveness of a particular advertisement can be evaluated by comparing the rate at which the beverage is dispensed during, following, and preceding, the display of particular advertisements. The optional counters described above can also or instead be used to track the number of times and time of day the advertisements are displayed. Periodically, and preferably in the same intervals as the payments or installments to the preferred provider, an advertising fee is calculated (block 116). Preferably, the advertising fee is based on the amount of beverage dispensed during the interval when the advertisements were displayed. However, alternative bases can also or instead be used, including without limitation the number of times and time of day the advertisements were displayed, advertising display time, and the like. This advertising fee is then used by the retailer to offset the lease or purchase payments made to the preferred provider (block 120). Preferably, the beverage provider pays the advertising fee directly to the preferred dispenser provider, thereby reducing the retailer's payment to the preferred provider. In other preferred embodiments, the advertising fee is paid directly to the retailer (however, it should first be determined that such a payment does not violate any applicable government regulations).

Although the advertising, revenue generation, and display payment process described above and illustrated in FIG. 3 is preferred, alternative embodiments of the present invention are possible. For example, advertising revenue (due to the retailer) can be determined and be payable in a number of different manners. Rather than being based upon the amount of beverage dispensed during the interval when the advertisements were displayed, advertising revenue due can be a flat fee payable periodically or in one or more lump sums (such as upon purchase of the dispenser 10), can be based in whole or in part upon the retailer's size, receipts from sales of beverages dispensed from the dispenser 10, the amount of beverage provided to the retailer by the provider, the size of the dispenser 10 (e.g., the number of dispensing nozzles in the dispenser 10), and the like, and be at least partially dependent upon the number, size, and type of display devices associated with the dispenser 10. In any case, the advertising revenue due need not necessarily be based upon the amount of beverage dispensed from the dispenser 10 or the number of times the advertisement(s) are displayed, although such bases are most preferred.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims. For example (and as suggested above), instead of determining and paying the advertising fee at regular intervals that substantially correspond to the payment intervals for the dispenser 10, the advertising fee could be estimated prior to the display of the advertisements by comparing the retail outlet that is currently purchasing the beverage dispenser 10 to a similarly situated retail outlet that has been advertising for a given amount of time. Such an estimate of the advertising fee could eliminate much of the tracking, monitoring, and reporting needed to independently calculate the advertising fee, and thereby save time and money for all parties involved.

If the beverage dispenser 10 is purchased in one lump sum payment, this estimated advertising fee would provide a good way of determining how much the base price could be reduced. In some cases, such lump sum purchase payments can be less attractive due to the uncertainty of estimating advertising fees and the possible need to police the retail outlet to be sure the advertisements being paid for are actually being displayed. Generally, the method of the present invention is preferably used in conjunction with leased dispensers or dispensers that are being paid off in regular installments, but nonetheless can be used in conjunction with lump sum purchases.

One having ordinary skill in the art will appreciate that a number of different hardware configurations are possible for the apparatus of the present invention. As mentioned above, the invention can be practiced with any type of beverage dispenser available, since the equipment needed for displaying the advertisements need not be mounted directly to the dispenser. Furthermore, any available hardware systems can be used to display the advertisements in the retail outlet. This includes systems and/or components purchased from third party vendors and systems that are already being used in the retail outlet for other purposes, such as television viewing or the broadcasting of music. Thus, the equipment needed to display the advertisements need not be purchased from the preferred dispenser provider directly and need not be dedicated to displaying advertisements. If this is the case, it can be desirable to have the display system inspected and/or approved by the beverage provider who will be doing the advertising.

If the display system is not dedicated to displaying advertisements, and the advertisements will not be shown substantially continuously or at approved intermittent increments, the metering device 30 can be linked to the output device 50 such that the advertising fee is calculated only for periods where the advertisements are being displayed. For example, the metering device 30 could track the amount of beverage dispensed only when the output device 50 is on and in the “play” mode (i.e., transmitting a signal to the viewing devices or the audio transmitting devices). This assumes, of course, that the output device 50 is not being used or cannot be used for purposes other than displaying the advertisements. The use of non-dedicated viewing devices may be appealing to retailers who often need additional viewing devices for special events.

We claim:

1. A beverage dispensing system comprising:
a base unit having at least one nozzle, the at least one nozzle dispensing a beverage;
a metering device that produces a first signal according to an amount of beverage dispensed from the at least one nozzle;
a timing device that produces a second signal according to a time of day that the at least one nozzle is dispensing the beverage;
a controller that receives the first signal and the second signal and produces an output signal; and
a display device including a television screen that displays a video signal coupled to the base unit.

2. The beverage dispensing system of claim 1, wherein the display device transmits a third signal to the controller based on a visual display that is being displayed.

3. The beverage dispensing system of claim 1, wherein the output signal is based on the time of day that the at least one nozzle is dispensing the beverage and a visual display produced by the display device.

4. The beverage dispensing system of claim 1, wherein the output signal is based on the amount of the beverage that is dispensed from the at least one nozzle and a visual display produced by the display device.

5. The beverage dispensing system of claim 1, wherein the output signal increases as the amount of the beverage increases.

6. The beverage dispensing system of claim 1, wherein the output signal is used to generate an invoice.

7. The beverage dispensing system of claim 1, wherein the timing device is configured to produce a third signal according to an amount of time that the at least one nozzle is dispensing the beverage.

8. The beverage dispensing system of claim 1, and further comprising at least one additional display unit positioned proximate to the base unit.

9. The beverage dispensing system of claim 1, wherein the beverage is at least one of water, beer, wine, liquor, soft-drink, sports drink, and juice.

10. A beverage dispensing system comprising:
a dispensing unit having at least one nozzle and a display device, the at least one nozzle dispensing a beverage and the display device producing a video display;
a metering device that produces a measurement signal according to an amount of the beverage dispensed from the at least one nozzle;
a timing device that produces a timing signal according to the time of day that the video display is produced by the display device; and
a controller that receives the measurement signal and the timing signal and produces an output signal.

11. The beverage dispensing signal of claim 10, wherein the display device transmits a visual signal according to the video display.

12. The beverage dispensing signal of claim 11, wherein the output signal is based on the measurement signal, the timing signal, and the video signal.

13. The beverage dispensing signal of claim 10, wherein the output signal is based on the amount of the beverage dispensed from the at least one nozzle and the visual display produced by the display device.

14. The beverage dispensing signal of claim 10, wherein the output signal increases as the amount of the beverage increases.

15. The beverage dispensing signal of claim 10, wherein the output signal is used to generate an invoice.

16. The beverage dispensing signal of claim 10, wherein the timing device produces a timing signal according to a time of day that the at least one nozzle is dispensing the beverage.

17. The beverage dispensing signal of claim 10, wherein the display device produces an audio and visual display.

18. The beverage dispensing signal of claim 10, and further comprising at least one additional display unit positioned proximate to the base unit.

19. A method of dispensing a beverage from a beverage dispenser, the method comprising:
producing a video display proximate to the beverage dispenser;
dispensing the beverage from at least one nozzle;
measuring an amount of the beverage being dispensed from the at least one nozzle;
generating a measurement signal according to the amount of the beverage;
generating a timing signal according to a time of day that the beverage is being dispensed; and
receiving the measurement signal and the timing signal and generating an output signal.

20. The method of claim 19, and further comprising transmitting a visual signal according to the video display.

21. The method of claim 20, and further comprising producing an output signal according to the measurement signal, the timing signal, and the visual signal.

22. The method of claim 19, and further comprising increasing the output signal as the amount of the beverage dispensed from the at least one nozzle increases.

23. The method of claim 19, and further comprising generating an invoice using the output signal.

24. The method of claim 19, and further comprising producing a signal within the timing device according to the amount of time that the at least one nozzle is dispensing the beverage.

25. The method of claim 19, and further comprising positioning at least one additional display unit proximate to the base unit.
